(19) United States
(12) Patent Application Publication
(10) Pub. No.: US 2026/0054237 A1
(43) Pub. Date: Feb. 26, 2026

(54) AUTOMATED FILL / FINISH SYSTEM

(71) Applicant: CELLUAR ORIGINS LIMITED, Melbourn (GB)

(72) Inventors: Dan Strange, Melbourn (GB); Ed Stone, Melbourn (GB); Paul Crisp, Melbourn (GB)

(21) Appl. No.: 19/107,349

(22) PCT Filed: Aug. 31, 2023
(86) PCT No.: PCT/GB2023/052260

§ 371 Date: Feb. 27, 2025

(30) Foreign Application Priority Data
Aug. 31, 2022 (GB) 2212685.8
Aug. 31, 2022 (GB) 2212687.4

(51) Int. Cl. B01F 33/85; B01F 31/22; B01F 31/55; B01F 35/22; B01F 35/71; B01F 35/90; B01F 35/92; B01F 101/22

(52) U.S. Cl. CPC B01F 33/85; B01F 31/22; B01F 31/55; B01F 35/2207; B01F 35/7135; B01F 35/714; B01F 35/717611; B01F 35/92; B01F 2035/98; B01F 2101/22

(57) ABSTRACT

A closed system (100) for mixing fluids for use in a bioprocessing system, comprising: automated means for manipulating a tube weld (160) between a first tube fluidly connected to a first consumable (10-1) and another tube fluidly connected to a mixing consumable (10-3), said tube weld forming a closed fluid connection between the first consumable and mixing consumable; automated means for transferring a first fluid contained by the first consumable to the mixing consumable via the fluid connection; and automated means for determining a quantity of fluid transferred to or from the mixing consumable, wherein the system is further configured to manipulate a tube weld between a second tube fluidly connected to a second consumable (10-2) and said another tube fluidly connected to the mixing consumable, and transfer a second fluid therebetween to be mixed with the first fluid in the mixing consumable.

### FIELD OF THE INVENTION

The present disclosure relates to an automated fill/finish system for use in an automated bioprocessing system, for example to perform final formulation and fill/finish of consumable bags prior to cryopreservation.

### BACKGROUND

Bioprocessing plays a crucial role in many industries including pharmaceuticals, foods, biofuels and other major sectors. It is no wonder that bioprocessing technologies, including bioprocessing systems, are increasingly relied upon as the bioprocessing industry continues to grow.

For example, bioprocessing is used for autologous cell therapies. Autologous cell therapies are a promising class of therapy, which have significant clinical and commercial potential ranging from treating cancer to fixing genetic defects. These therapies involve taking cells from a patient, manipulating the cells over the course of days to weeks, and re-introducing the cells back into that patient's body to produce a therapeutic effect. The steps taken during autologous cell therapies are often complex; for example, a typical CAR-T process may involve a sequence of steps starting with a cryopreserved leukopak, thawing, washing to remove DMSO, enrichment of T cells, activation, transduction, expansion, concentration, formulation fill/finish into an IV bag, and cryopreservation, with several other intermediate washing steps.

Due to the complexity of bioprocessing, there is a desire to automate the process while maintaining a closed system that removes the need to perform the steps in such a high-grade cleanroom. A closed system is one where there is no exposure of the process to the surrounding environment such that there can be no ingress of contaminants from the environment or cross contamination from other processes that are being performed simultaneously. There are systems that have tried to provide a solution to this involving a complex consumable, which connects the sample to all the other necessary processing stations, for example via a tube that is fluidly connected to the consumable, and provides pumping and valving to allow the steps to be performed in a particular sequence. The term “consumable” may be used to describe any container, such as an IV bag, containing a sample such as a fluid. The fluid may contain one or more of: cellular samples, reagents, cryoprotectants or any other various fluids. However, these consumables are complex to manufacture and install and are consequently relatively expensive, and potentially unreliable. Each consumable needs to be individually tailored to the process being performed, making the system inflexible to modifications and expensive to adapt to new processes. Indeed, a challenge to automate such systems is how to provide a system flexible to modifications that is also able to provide a reliable connection between the consumable and other fluid containers, whilst maintaining a sterile, closed system.

Tube welding may be used to form fluid connections between tubes that connect to respective containers (i.e. “consumables”). Sterile tube welders allow connections to be made between two tubes with closed ends without exposing the contents of either tube to the environment, and are the only widely accepted means of reusably creating connections within a single system. However, tube welding requires precise manipulation to insert the tubes into the welder correctly, and need visual inspection by an operator after each weld to confirm successful welding.

Challenges arise in automated systems because the tubes connected to the consumable are typically free moving, making it difficult for an automated bioprocessing system to locate the tube and its tube end for insertion into the welder. Further, long lengths of tubing are required for tube welding which increases the risk of the tubes in the system becoming tangled and/or interfering with other components in the system. As such, there has been little progress in attempts to automate bioprocessing systems that utilise tube welding, due to these substantial complexities, and the strict requirements for reliability when applied to a bioprocessing system. Furthermore, for autologous cell therapies and alike, it is particularly difficult to incorporate the use of consumables into an automated bioprocessing system due to their limp, flexible nature and their stiffness which changes based on the volume of fluid held within the consumable. Such characteristics make it difficult for an automated system to accurately hold and locate the consumable during processing.

One challenge faced when automating a bioprocessing method is the final “fill/finish” stage where a cell product is mixed with a cryoprotectant and supplied to a large number of “output consumables” before being cryopreserved for storage and transport. Once the cell product is mixed with the cryoprotectant, there is only a short period (about one hour) in which the output consumables must be cryopreserved before the cryoprotectant damages the cells. Due at least in part to the aforementioned difficulties with handling and connection of tubes while maintaining a closed system, existing systems typically pre-connect the output consumables to a mixing chamber. However, this may limit the number of output consumables to about ten, may be space inefficient, and is inflexible to scaling or modification of the process. Furthermore, there may be a risk of cross contamination, and there is no simple way to validate that contamination has not occurred.

For the reasons stated above, there is a need for an automated system that can handle and process consumables efficiently while maintaining a closed environment.

### SUMMARY OF INVENTION

Described herein is a closed system for mixing (e.g. reagent) fluids for use in a bioprocessing system, comprising: automated means for manipulating a tube weld between a first (e.g. flexible) tube fluidly connected to a first consumable and another (e.g. flexible) tube fluidly connected to a mixing consumable, said tube weld forming a closed fluid connection between the first consumable and mixing consumable; automated means for transferring a first fluid contained by the first consumable to the mixing consumable via the fluid connection; and automated means for determining a quantity of fluid transferred to or from the mixing consumable, wherein the system is further configured to manipulate a tube weld between a second tube fluidly connected to a second consumable and said another tube fluidly connected to the mixing consumable, and transfer a second fluid therebetween to be mixed with the first fluid in the mixing consumable.

Such a system provides a quick load and unload time of the consumables when compared to prior art systems. This is advantageous when mixing the contents of consumables since the mixture may be prone to separation or for example, cryoprotectant is toxic to cell samples such that the process must be performed quickly. Manipulating a fluid connection between the consumables reduces internal contamination and reduces the need for additional labour to carry out this step. Advantageously, the system may be configured as an automated fill/finish system for a bioprocessing system. The fill/finish system may be configured to mix cell product contained in a first consumable with cryoprotectant contained in a second consumable.

Preferably, at least a portion (e.g. an end portion) of the first tube is flexible. Similarly, at least a portion (e.g. an end portion) of said “another” tube is preferably flexible. Indeed, a portion (e.g. an end portion) of each of the tubes that are manipulated (as described herein) to form a fluid connection is preferably flexible. As such, a tube may be referred to as a “flexible tube”, which term may also include a portion of a tube that is flexible, such as an end portion.

As used herein, the term “automated” or “autonomous” preferably connotes that a particular system or step may be operated and/or controlled by automation, e.g. automatically, without the need for human intervention. For example, the closed system may follow an automated sequence of operation.

As used herein, the term “closed system” may connote a functionally closed system, or more preferably a fully closed system, where a physical barrier is maintained between the contents of the consumables and the surroundings, such as other parts of the bioprocessing system. In this way, the risk of contamination of the consumables or the surroundings is reduced.

The means for determining a quantity of fluid transferred to or from the mixing consumable may monitor a property of the mixing consumable, such as its weight or a volume of fluid contained therein. Alternatively, or additionally, the means for determining may monitor a property of a different consumable, such as the first and second consumable and/or an output consumable that receives fluid from the mixing consumable. Alternatively, or additionally, the means for determining a quantity of fluid may monitor a flow rate of fluid through one or more of the fluidly connected tubes. Advantageously, the means for determining may allow for precise volumes of fluid to be pumped between consumables. For example, it is advantageous for output consumables to have a precise volume of the mixture contained therein.

The automated means for manipulating a tube weld may be configured to form a closed, sterile, and/or aseptic tube weld between the respective tubes of two consumables. In other words, the “means for manipulating” may comprise a “tube welder” or “tube welding apparatus”.

The automated means for manipulating a tube weld may further comprise means for engaging and/or positioning a tube, at least a portion (e.g. an end portion) of which is preferably flexible.

The automated means for transferring may be arranged to transfer fluid between two fluidly connected consumables via said tubes that have been welded together to form said fluid connection. The automated means for transferring fluid may comprise a pumping arrangement configured to apply a pumping action to at least one of said tubes forming a fluid connection, preferably a peristaltic pumping action. In other words, the means for transferring fluid may be a “peristaltic pump”.

The system (e.g., the automated means) may be further configured to manipulate a tube weld between a tube fluidly connected to the mixing consumable and a tube fluidly connected to an output consumable and to transfer (at least some of) the mixture (e.g., of the first and second fluids) contained in the mixing consumable to the output consumable. The system may further comprise automated means for disconnecting a fluid connection between two consumables.

The system may further comprise automated means for sealing each tube once a transfer of fluids to or from the mixing consumable is complete. The automated means for sealing may be an RF sealer or a heat sealer. The automated means for sealing may also provide the means for disconnecting a fluid connection between two consumables. The automated means for sealing may be configured to seal the tubes connected between the mixing consumable and the first consumable and/or the second consumable. Alternatively, the first consumable and the second consumable may remain connected to the mixing consumable after a transfer of fluid to the mixing consumable is complete. The automated means for sealing may be configured to seal other consumables, such as output consumables containing the mixture transferred from the mixing consumable. In this way, the filled output consumables may be removed from the system.

The automated means for manipulating a tube weld may further comprise means for engaging and/or positioning a tube, at least a portion (e.g. an end portion) of which is preferably flexible. Alternatively, or additionally, at least a portion of the first tube that is fluidly connected to the first consumable is retained, at least in part, along a predetermined path.

By retaining a portion of the tube along a predetermined path, the tube can be reliably engaged by a robotic device at any position along said predetermined path. As used herein, the term “predetermined path” preferably indicates that the position of the tube is known at one and preferably a plurality of locations along its length, thereby defining a known path therebetween said known positions. It will be appreciated that the entirety of the tube is not required to have a predetermined path, provided that at least part of the tube has a sufficiently known path to allow it to be reliably engaged by an automated system (e.g., a robotic device).

The known positions may be defined relative to other components in the system such as features with fixed locations (e.g. tube retaining elements having known locations), and/or by one or more identification marks on the tubes. More preferably, the location of the tube is known along at least one continuous length of the tube. The predetermined path may include one or more linear path portions, which may be provided by retaining the tube between one or more pairs of tube retaining elements; this aligns the tube substantially along a known axis.

The system may comprise an automated processing station, and more preferably a stand-alone automated processing station. As used herein, the term “processing station” preferably connotes a station of the bioprocessing system that is configured to perform a particular part of a bioprocessing method, such as a fill/finish operation. The processing station may be located at a fixed location in the bioprocessing system during a bioprocessing method. As used herein the term “stand-alone” preferably connotes that the processing station is self-contained and may perform an operation such as a fill/finish operation without any external intervention. Alternatively, the processing station may interact with other robotic devices, which may move around the bioprocessing system. As used herein, the term “automated” preferably indicates that at least one process is performed autonomously by the processing station. An autonomous process may occur without operator intervention and may be defined according to a bioprocessing workflow.

At least one of the automated means for manipulating a tube weld, the automated means for transferring fluid and the automated means for sealing may be provided on the processing station. Alternatively, at least one of the automated means for manipulating a tube weld, the automated means for transferring fluid and the automated means for sealing is provided on a separate mobile unit (e.g., a “mobile manipulation unit”) configured for automated cooperation with the processing station. The system may comprise a plurality of mobile manipulation units; each of the mobile manipulation units may be able to perform one or more of the manipulation, transferring, sealing and/or disconnection operations in the bioprocessing system. Preferably, at least one of the automated means for manipulating a tube weld, the automated means for transferring fluid and the automated means for sealing comprises a robotic device, such as a robotic arm having an end effector configured to perform one or more of the operations (i.e., manipulating, transferring, sealing and/or disconnection operations).

The automated means for transferring may comprise a pumping arrangement configured to apply a pumping action to at least one of said tubes forming a fluid connection, preferably a peristaltic pumping action. The system may further comprise automated means for disconnecting a fluid connection between two consumables.

The system may further comprise automated means for mixing the first and second fluids within the mixing consumable. For example, the system may further comprise a mixing system provided on the processing station.

The means for mixing may comprise an automated mixing system may comprise a mixing zone in which the mixing consumable is positioned to receive the first and second fluids from the first and second consumables, respectively. The mixing system may comprise means for agitating a mixture of the contents of the first and second consumables.

The means for agitating may comprise a roller arranged to be rolled across the mixing consumable and/or a rocker plate arranged to rock the mixing consumable thereby to promote mixing of the first and second fluids. The means for agitation may comprise an ultrasound source, a vibration source, and/or an orbital shaker. The mixing system may comprise means for controlling the temperature of the mixing consumable, such as a Peltier device or plate configured to cool the mixing consumable located in the mixing zone.

The processing station may comprise a plurality of slots configured to (e.g., releasably) retain said first consumable, said second consumable, and said output consumable. Preferably, the slots are arranged adjacent to the mixing system to facilitate manipulation of the tube weld between said first, second and output consumables and the mixing consumable. The slots may be arranged in a linear array. The slots may be arranged above the mixing system. The first, second and output consumables may each be provided in the device described herein, thereby allowing any of the consumables to be added, retained, and/or removed from any of the slots. The slots may be arranged on a front facing surface of the processing station, such as to enable manipulation of the consumables by a robotic device.

The robotic device may be part of the processing station or may be a separate robotic device that can move relative to the processing station (e.g., mobile unit or “mobile manipulation unit”). Where the robotic device is a mobile manipulation unit, the mobile manipulation unit may be able to move autonomously around a floor of the bioprocessing system to access processing station, or the mobile manipulation unit may be mounted on a rail (or a network or rails) to facilitate movement around the bioprocessing system.

The mobile unit may be configured to deliver at least one of said first consumable and said second consumable to the plurality of slots to facilitate supply of at least one of the first fluid or the second fluid to the mixing system. The mobile unit may be configured to perform the manipulation, transfer, sealing and/or disconnection operations. The delivery, manipulation, transfer, sealing and disconnection operations may be performed by the same robotic device (such as the same mobile manipulation unit). Alternatively, these functions may be performed by different robotic devices, which may be part of the processing station or may be separate to the processing station (i.e., a second mobile manipulation unit). For example, a first mobile manipulation unit may deliver (and/or remove) the consumables to (or from) the plurality of slots, and a second mobile manipulation unit (or robotic device that is part of the processing station) may manipulate the tube weld, transfer fluid, seal and/or disconnect a tube. Preferably, each mobile manipulation unit is capable of performing all of the delivery, manipulation, transfer, sealing, and disconnection operations, though it will be appreciated that during use, these tasks may be divided between different robotic devices, such as between different mobile manipulation units.

The processing station may comprise a (first) automated conveying system configured to deliver at least one of said first consumable and said second consumable to the mixing system for supply of at least one of the first fluid or the second fluid to the mixing system. The first automated conveying system may be referred to as an input conveying system.

Said automated conveying system may be further configured to deliver both the first and second consumables to the mixing system for supply of both the first fluid and the second fluid to the mixing system.

The input conveying system may deliver other consumables to the mixing system, such as empty output consumables.

The processing station may further comprise a (second) automated conveying system configured to remove the output consumable from the mixing system once filled with the resulting mixture of first and second fluids. The second automated conveying system may be referred to as an output conveying system. The output conveying system may remove other consumables from the mixing system, such as empty first and second consumables.

The, or each, automated conveying system may be arranged to position the consumables for engagement by the means for manipulating a tube weld between each consumable and the mixing system. The conveying system may comprise a motorised rail arrangement in which the consumables are suspended from a rail along which they can be moved via a motorised track. The, or each, automated conveying system may be used together with one or more robotic devices and/or one or more of the mobile manipulation units discussed above. The system may be configured to retain the consumables and their corresponding tubes at one or more predetermined positions; in this way, the means for manipulating a tube weld (such as a robotic device) may reliably engage the tubes at predetermined positions or on predetermined path. For example, the system may be configured to engage consumables and tubes held within the device described herein, where the device is configured to retain the tube, at least in part, along a predetermined path.

The system may further comprise means for identifying an identification mark on at least one of the consumables. The system may further comprise one or more sensors configured to measure one or more parameters of the consumables.

Also described herein is a closed system for mixing (e.g. reagent) fluids for use in a bioprocessing system, comprising: automated means for mixing a first fluid, contained by a first (e.g. “input”) consumable, with a second fluid, contained by a second (e.g. “input”) consumable, within a third (e.g. “mixing”) consumable prior to filling a fourth (e.g. “output”) consumable with a resulting mixture of said first and second fluids, wherein each consumable comprises a tube (at least a portion (e.g. an end portion) of which is preferably flexible) arranged to provide a fluid conduit to the one or more fluids contained by the consumable; automated means for manipulating a closed fluid connection between two of said consumables for the transfer of fluid therebetween; automated means for transferring fluid between two fluidly connected consumables; automated means for determining the weight of a volume of the resulting mixture of first and second fluids that is transferred to the fourth consumable; and automated means for sealing a portion of each tube such that the one or more fluids in a consumable can be aseptically sealed from the surrounding environment prior to disconnecting a fluid connection manipulated between two consumables.

Also disclosed herein is a method of mixing fluids for bioprocessing, comprising mixing two or more using and/or within a closed system as described above and herein.

Also described herein is a method of mixing (e.g. reagent) fluids within a closed system for use in a bioprocessing system, the method comprising: mixing a first fluid, contained by a first consumable, with a second fluid, contained by a second consumable, within a mixing consumable prior to filling an output consumable with a resulting mixture of said first and second fluids, wherein each consumable comprises a tube (at least a portion (e.g. an end portion) of which is preferably flexible) arranged to provide a fluid conduit to the one or more fluids contained by the consumable; manipulating a fluid connection between two of said consumables for the transfer of fluid therebetween; determining the weight of a volume of the resulting mixture of first and second fluids that is transferred to the output consumable; and sealing a portion of each tube such that the one or more fluids in a consumable can be isolated from the surrounding environment prior to disconnecting a fluid connection manipulated between two consumables.

Preferably, one or more of the above-described steps of “mixing”, “manipulating a fluid connection”, “determining the weight” and “sealing a portion” are performed autonomously, and more preferably all of these steps may be automated, whereby the method may therefore be described as an “automated method”.

Also described herein is a device for holding a consumable (e.g. bag) for use in an automated bioprocessing system, the consumable having at least one flexible tube fluidly connected thereto, the device comprising: a first portion for holding the consumable; and a second portion configured to retain the flexible tube, wherein the second portion is configured to retain the flexible tube, at least in part, along a predetermined path.

By retaining a portion of the tube along a predetermined path, the tube can be reliably engaged by a robotic device at any position along said predetermined path. As used herein, the term “predetermined path” preferably indicates that the position of the tube is known at one and preferably a plurality of locations along its length, thereby defining a known path therebetween said known positions. It will be appreciated that the entirety of the tube is not required to have a predetermined path, provided that at least part of the tube has a sufficiently known path to allow it to be reliably engaged by an automated system (e.g., a robotic device).

The known positions may be defined relative to other components of the device such as features with fixed locations (e.g. tube retaining elements or a means for engagement), or by one or more identification marks on the tubes. More preferably, the location of the tube is known along at least one continuous length of the tube. The predetermined path may include one or more linear path portions, which may be provided by retaining the tube between one or more pairs of tube retaining elements; this aligns the tube substantially along a known axis.

Advantageously, the first portion provides a means for holding the consumable, which is typically a fluid-filled bag that is limp and flexible, such that the first portion provides support to the consumable. Furthermore, the second portion provides a means for retaining the at least one flexible tube thereby reducing its free movement such that one or more positions of the flexible tube along the predetermined path is known. Indeed, by following a predetermined path, a system (such as the system described above and herein) that is programmed to know or recognise the predetermined path will, therefore, also know the location of the retained said portion of flexible tube. In this way, the flexible tube can undergo manipulation by the system. This manipulation may include welding the flexible tube to another tube by, for example, an automated robotic arm, which would require an end portion of the tube to be found, gripped and manipulated by the system. For example, the device may be located in a slot, storage section, or conveying system of the system described above and herein. During use, an automated means for manipulating a tube weld (such as a tube welder on a robotic arm) may engage the tube along the predetermined path so that fluid connections and subsequent fluid transfers can be made. In existing systems, engagement of tubes may be particularly challenging, since the flexibility of the tubes can result in them not typically being located at well-defined positions in space; therefore, connections made between flexible tubes may be unreliable.

The first portion may comprise a structure configured to hold the consumable. Advantageously, the structure supports the consumable thereby reducing the flexibility of the consumable. The structure may be rigid.

The structure may be configured as a tray having a plurality of sides defining a recessed portion into which the consumable is held. The tray provides further support to the consumable by providing a sturdy hold on the consumable. In this way, the consumable maintains a relatively fixed shape. Since the consumable is held within a tray, the varying stiffness based on the volume of fluid in the consumable is no longer detrimental to the functionality of the system as the tray may be easily moved between various locations since the tray is moveable.

At least one of the sides defining the recessed portion may have a groove or slot or hole for allowing the tube to pass through. This allows a portion of the tube to lead outside of the tray without incurring any deformation of the tube by the sides of the tray. Therefore, steady and reliable fluid communication between the tube and the consumable can be achieved.

The second portion may comprise a frame. The second portion (e.g., the frame) may have at least one tube retaining element arranged to retain the tube in at least one position along the predetermined path. In this way, the tube is securely retained in a position by the at least one tube retaining element thereby reducing undesired free movement of the flexible tube.

The tube retaining element may by any suitable means for retaining the portion of tube including a clip, a hook or a clasp. The portion of tube may be permanently held by the at least one tube retaining element or it may be removably secured.

The second portion (e.g., the frame) may have a plurality of tube retaining elements arranged to retain the tube at a plurality of positions along the predetermined path. This further reduces undesired free movement of the flexible tube by securely retaining the flexible tube in a plurality of positions. At least one of the plurality of positions may be identifiable by an identification mark such as a unique bar code, QR code, RF tag, and/or NFC tag. The identification mark may each be located at the same position as one of the plurality of retaining elements; in this way the positions along the predetermined path may be identified by a system with a means for identifying an identification mark, such as the closed system described above and herein. In this way, the system will know the location of the retained flexible tube.

The frame may be configured as a lattice or grid. The lattice or grid may comprise a first set of parallel bars which cross at reoccurring intervals with a second set of parallel bars. The bars may have a rigid structure. The first and second set of parallel bars may be at right angles to one another. Advantageously, this arrangement provides ease of movement for an automated system, for example an automated robot arm may be programmed for translational movements (i.e. upward and downward movements) enabling it to easily move along the lattice or grid. Additionally, a grid is suitable base for providing a winding predetermined path for the at least one tube such that a long tube can be held in a compact arrangement, thereby conserving space.

The at least one tube retaining element may be arranged to retain the tube at an intermediate position on the lattice or grid. The term “intermediate position” refers to a position at substantially the midpoint between two intersecting bars. In this way, a robot arm of an automated system can move between the plurality of positions along the predetermined path using only translational movement.

The second portion may be arranged to provide a lid to the first portion such that a consumable is retained therebetween. A lid covering the consumable is useful for stacking multiple consumable holders on top of one another, thereby conserving space. The consumables may be stacked within the closed system such as in a storage section of the processing station. Additionally, the lid covering the consumable provides protection to the consumable thereby reducing the likelihood of damage to the consumable and reducing the risk of contamination.

The second portion may be slidable relative to the first portion. Preferably the second portion may be slidable parallel to a longitudinal axis of the first portion.

Alternatively, the second portion may be hingedly attached to the first portion and configured for hinged movement between an open configuration and a closed configuration. Preferably, the axis parallel to the plane of the first portion and an axis parallel to the plane of the lid lie parallel to one another when in the open configuration, thereby improving accessibility of the flexible tube and/or the consumable by a robotic device. The robotic device may be programmed to move the consumable holder between the two configurations.

The second portion may be securable to the first portion in the closed configuration. This increases stability when stacking multiple consumable holders and improves the protection provided to the consumable in the holder when in a closed configuration.

The device may further comprise means for cooling a consumable held in the first portion. The means for cooling may comprise at least one air port in the first portion and/or the second portion. The air port may be configured to receive a supply of cool air from an external air source.

Preferably, the plurality of tube retaining elements comprises a first tube clip and a second tube clip, wherein the tube clips are spaced apart to provide the predetermined path therebetween.

Alternatively, the first portion may comprise: a tray with a cavity shaped to receive the consumable therein, a removable cover arranged to enclose the consumable within the cavity.

The device may further comprise a means for engagement to facilitate manipulation of the device, preferably provided on the first portion of the device.

The device may further comprise an identification mark to facilitate identification of a consumable held within the device.

It will be understood by a skilled person that any apparatus feature described herein may be provided as a method feature, and vice versa. It will be understood that particular combinations of the various features described and defined in any aspects described herein can be implemented and/or supplied and/or used independently.

Moreover, it will be understood that embodiments are described herein purely by way of example, and modifications of detail can be made within the scope of the disclosure. Furthermore, as used herein, any “means plus function” features may be expressed alternatively in terms of their corresponding structure.

### BRIEF DESCRIPTION OF DRAWINGS

One or more embodiments will now be described, by way of example, with reference to the accompanying figures, in which:

FIG. 1 shows a first embodiment of a closed system;

FIGS. 2 to 4 show a second embodiment of a closed system;

FIG. 5 shows a third embodiment of a closed system;

FIG. 6a shows an example of some output consumables;

FIG. 6b shows an example of a cassette frame for holding a plurality of consumables;

FIG. 7 shows a schematic diagram of a plurality of consumables fluidly connected to a tube network;

FIG. 8 shows a schematic diagram of a first configuration of tools and consumables that may be operated according to a first workflow;

FIG. 9 shows a schematic diagram of a second configuration of tools and consumables that may be operated according to a second workflow;

FIG. 10 shows a schematic diagram of an alternative implementation of a means for transferring reagent between two fluidly connected consumables;

FIGS. 11a and 11b show a first embodiment of a device for holding a consumable having at least one flexible tube connected thereto in open and closed configurations, respectively; and

FIGS. 12a and 12b show a second embodiment of a device for holding a consumable having at least one flexible tube connected thereto.

### DETAILED DESCRIPTION

In the following description and accompanying drawings, corresponding features may preferably be identified using corresponding reference numerals to avoid the need to describe said common features in detail for each and every embodiment.

In general terms, described herein is an automated system (e.g. comprising a processing station) configured to connect consumables (e.g. bags) together aseptically, to pump fluid between them, and to seal them aseptically. In more detail, the system is configured to connect aseptically a first “input” consumable (e.g. containing cells), preferably using a robotic tube welder, to a larger mixing consumable and then transfer the contents from the first consumable into the mixing consumable, preferably using a robotic pumping means (e.g. a pumping mechanism). The system may then aseptically connect a second “input” consumable (e.g. containing cryoprotectant) to the larger mixing consumable using the robotic tube welder and transfer some, or all, of the contents from the second consumable into the mixing consumable using the robotic pumping means. The first and second consumables can then be disconnected from the mixing consumable (while maintaining sterility), preferably using a robotic tube sealer, which may be part of the robotic tube welder. The mixing chamber may be gently rocked to mix the fluids while they are cooled, or example using a Peltier.

The system may then sequentially aseptically connect, preferably using the robotic tube welder, the mixing consumable to one or more output (“product”) consumables, prior to performing a controlled transfer of fluid between the mixing consumable and each output consumable container preferably using the robotic pumping means. The output consumable may then be disconnected, preferably using the robotic tube sealer. This final “controlled transfer” step may be repeated until all of the fluid contained in the mixing consumable has been dispensed.

As will be appreciated, in a preferred embodiment, the system could be described as a robotic welding/sealing/pumping and conveying system for performing fill/finish operations.

In summary, as will be described in more detail further on with reference to various embodiments, the system comprises automated means to connect consumables together aseptically, to pump fluid between them, and to then aseptically seal the consumables. Ideally, the system also comprises automated means to perform mixing of the fluids in the mixing consumable and automated means to accurately measure the weight of fluid being dispensed to or from the mixing consumable. Means for cooling the mixing consumable, to maintain a desired temperature of the mixed fluids are also preferred, as are means to maintain traceability of the input and output fluids.

As previously mentioned, the consumables referred to herein are preferably bags configured to contain fluids, each bag having a flexible tube providing a fluid connection to its contents, the tube being sealed (e.g. pinched shut) prior to connection to the tube of another such consumable.

Automated “aseptic” connection and disconnection technology providing part of the system described herein enables large numbers of consumables (e.g. bags) to be filled quickly, which is not possible with existing systems that can typically fill only 10 preconnected bags at a time. Indeed, the system described herein provides much quicker load and unload times than existing systems, which require manually connecting input consumables at the beginning of the process and then manually disconnecting/heat sealing all of the output consumables once the transfer of fluids is complete.

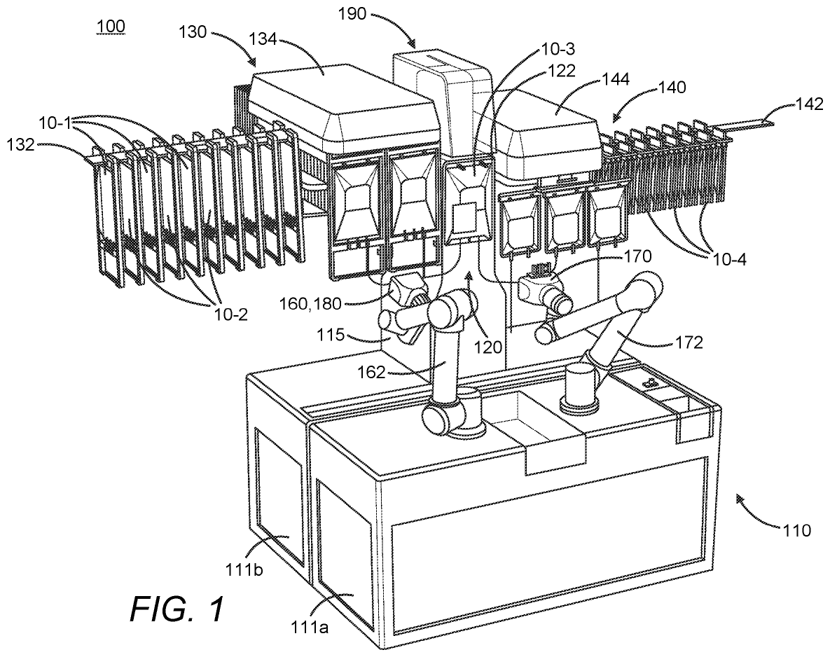

FIG. 1 shows a first embodiment of a closed system 100 that may form part of a bioprocessing system. Following steps in a cell therapy process such as enrichment, activation, transduction, expansion, and/or concentration, the system 100 may be configured to perform a fill/finish operation where cell product is mixed with cryoprotectant, and the mixture is dispensed into a plurality of smaller “output” consumables 10 for subsequent cryopreservation. Therefore, the system 100 may be referred to as a fill/finish system 100, though it will be appreciated that the system 100 may be operated for other purposes. The fill/finish operation must be performed quickly, since the cryoprotectant can be toxic to the cells; in particular, all the output consumables 10 must be filled, sealed and cryopreserved within one hour. As will be described in more detail further on, the system 100 has several features that may enable accurate and consistent mixing of the cells with the cryoprotectant, allow temperature control of the consumables 10, and are gentle to the cells, all while enabling a large number of output consumables 10 to be filled with the mixture within a short time period.

As shown in FIG. 1, the system 100 may be configured as a processing station 110, such as a fill/finish station 110. By implementing the system 100 at a processing station 110, all the steps required for the fill/finish operation may be carried out in one location, thereby simplifying control of the processing station 110 and transport of the consumables 10 to and from the processing station 110.

The system 100 comprises an automated means for mixing 120 a first reagent, contained by a first consumable 10-1, with a second reagent, contained by a second consumable 10-2, within a third consumable 10-3 prior to filling a fourth consumable 10-4 with a resulting mixture of said first and second reagents. The first and second consumables 10-1, 10-2 may be referred to as “input consumables”. The third consumable 10-3 may be referred to as a “mixing consumable”. The fourth consumable 10-4 may be referred to as an “output consumable”, such as a “vial” or “vessel”.

Where the system 100 is configured as a fill/finish system 100, the first consumable 10-1 may contain cell product, and the second consumable 10-2 may contain cryoprotectant and optionally any formulation for infusion. It will be appreciated that the first and second consumables 10-1, 10-2 are interchangeable within the scope of the present disclosure. Furthermore, the first and second consumables 10-1, 10-2 may contain different reagents and/or additional reagents or mixtures of reagents. As used herein, the term “fluid” may refer to any liquid or gas, including the reagents, cell samples, infusion formulation, cryoprotectant, and/or any mixtures thereof. Additional input consumables 10-1, 10-2 may be provided for transfer of their contents into the mixing consumable 10-3.

The mixing consumable 10-3 preferably has a larger volume than the input consumables 10-1, 10-2 so that first and second reagents may be fully contained within the mixing consumable 10-3. For a fill/finish operation, the mixture of the first and second reagents is dispensed into a plurality of the output consumables 10-4, for example between 4 and 100 output consumables 10-4. The output consumables 10-4 may therefore have a smaller volume than the input consumables 10-1, 10-2 and/or the mixing consumable 10-3. Where appropriate, the term “consumable” may refer to any of the first, second, third, and/or fourth consumables 10. The manipulation of a fluid connection and the transfer of reagent between each of the consumables 10 will be described in more detail further on.

Each consumable 10 comprises a flexible tube 11 arranged to provide a fluid conduit to the one or more reagents contained by the consumable 10. The flexible tube 11 has a “upstream end” that fluidly connects to the corresponding consumable 10, and a “downstream end” that defines a sealed or closed end of the tube 11. Optionally, a consumable 10 may have more than one tube 11 connected, in order to facilitate multiple connections and/or transfers of reagent to occur simultaneously. As will be discussed in more detail further on, a tube welder 160 may be used to form closed fluid connections between consumables 10 via their respective tubes 11.

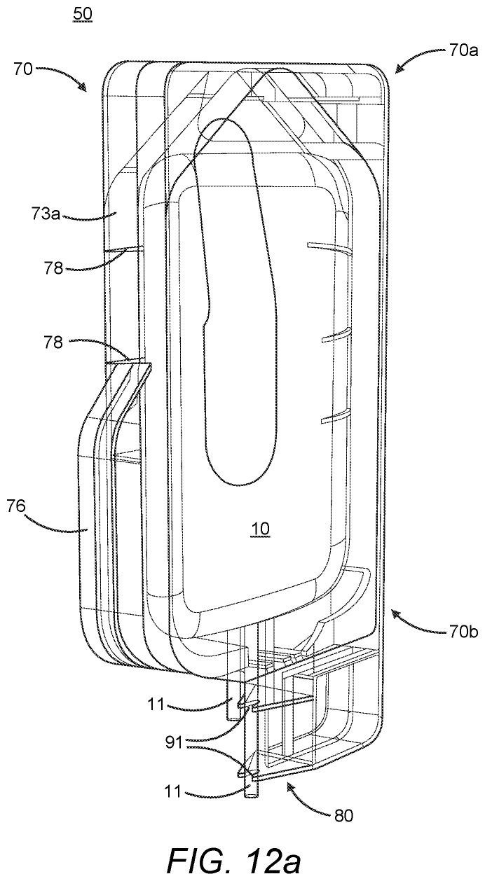

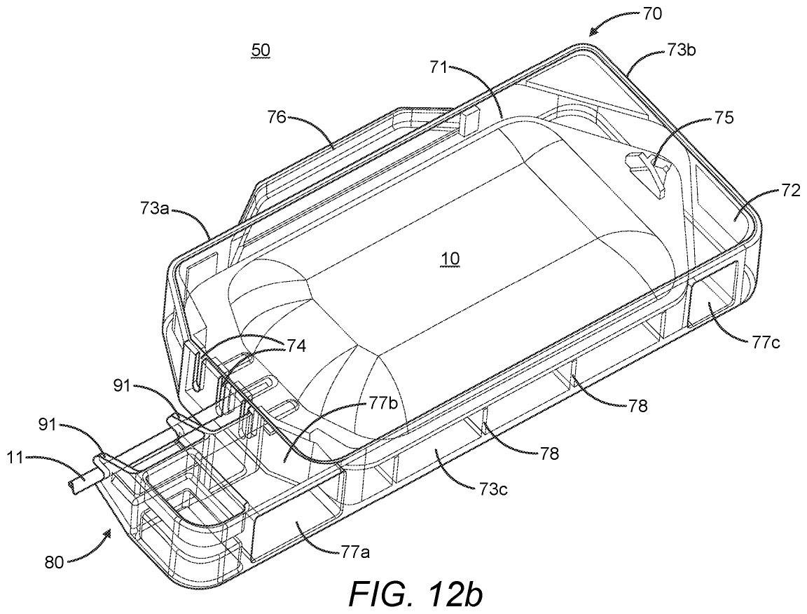

Multiple fluid connections may be formed between the mixing consumable 10-3 and a plurality of the output consumables 10-4. Therefore, the mixing consumable 10-3 should have a sufficient length of tube 11 to allow for multiple connections and disconnections by the tube welder. To prevent entanglement of this length of tube 11 with other parts of the system 100, and to facilitate engagement by the tube welder 160, the mixing consumable 10-3 may be held within a device 1 that retains the tube 11 along a predetermined path. An example of such a device 1 will be discussed further in relation to FIG. 11. The other (input and/or output) consumables 10 may also be held within devices (such as rigid trays) with tube alignment features to assist with robotic movement and tube location. An example of another device 50 for holding a consumable 10 will be described in relation to FIG. 12.

The automated means for mixing 120 may comprise a mixing system 120 provided on the processing station 110, which may be a “stand-alone” station 110 (or “apparatus”) for a bioprocessing system. The mixing system 120 may comprise a mixing zone 122 in which the third consumable 10-3 is positioned to receive the first and second reagents from the first and second consumables 10-1, 10-2, respectively.

The mixing system 120 may comprise means for agitating a mixture of the contents of the first and second (input) consumables 10-1, 10-2. For example, the means for agitating may comprise a roller (not shown) arranged to be rolled across the mixing consumable 10-3 thereby to promote mixing of the first and second reagents. Alternatively, or additionally, the means for agitating may comprise a rocker plate (not shown) on the mixing zone 122 arranged to rock the mixing consumable 10-3 thereby to promote mixing of the first and second reagents. Other examples of a means for agitating may be an ultrasonic source, a vibration source, or an orbital shaker. Any of these means for agitating may be provided in any suitable combination, depending on requirements.

The mixing system 120 may comprise means for controlling the temperature of the mixing consumable 10-3. For example, the mixing zone 122 may comprise a Peltier device or cold plate (not shown) configured to cool the mixing consumable 10-3 when located in the mixing zone 122. The means for controlling the temperature may be configured to maintain the mixing consumable 10-3 at a temperature of about 4 degrees.

The system 100 (preferably the processing station 110) may comprise a first automated (“input”) conveying system 130 configured to deliver at least one of said first consumable 10-1 and said second consumable 10-2 to the mixing system 120 for supply of at least one of the first reagent and the second reagent to the mixing system 120.

Preferably, the (first) automated conveying system 130 is further configured to deliver both the first and second consumables 10-1, 10-2 to the mixing system 120 for supply of both the first reagent and the second reagent to the mixing system 120. The conveying system 130 may also deliver empty fourth consumables 10-4 to be filled with the mixture of the first and second reagents from the mixing system 120. The conveying system 130 may comprise a rail system 132, comprising one or more rails along which a consumable 10 (e.g. a first consumable 10-1 and/or a second consumable 10-2) may be configured to be moved. The conveying system 130 may comprise a means for moving (not shown) the consumables 10 along the rail 132 thereby to sequentially locate them adjacent to the mixing system 120. For example, the rail system 132 may comprise a motorised track (not shown), whereby consumables 10 may be suspended from the rail 132 along which they can be moved via the motorised track.

The processing station 110 may further comprise a second automated (“output”) conveying system 140 configured to remove the fourth consumable 10-4 from the mixing system 120 once filled with the resulting mixture of the first and second reagents. The (second) conveying system 140 may remove other consumables 10 from the mixing system 120, such as empty first and second consumables 10-1, 10-2. Similar to the (first) “input” conveying system 130, the (second) “output” conveying system 140 may comprise a rail system 142 comprising one or more rails along which a consumable 10 (e.g. a fourth consumable 10-4) is configured to move. The conveying system 140 may comprise means for moving (not shown) the consumables 10 along the rail 142 thereby to sequentially locate them adjacent to the mixing system 120. As with the (first) conveyor system 130, the rail 142 may comprise a motorised track (not shown), whereby consumables 10 may be suspended from the rail 142 along which they can be moved via the motorised track.

The rail 142 of the conveying system 140 may be contained within a refrigeration tunnel/section to maintain the temperature of the output consumables 10-4 at about 4 degrees.

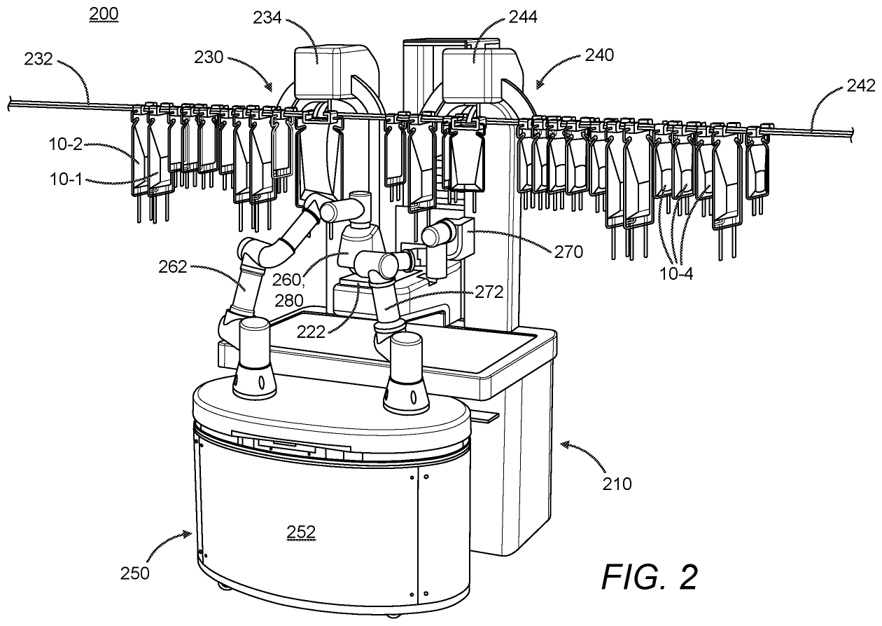

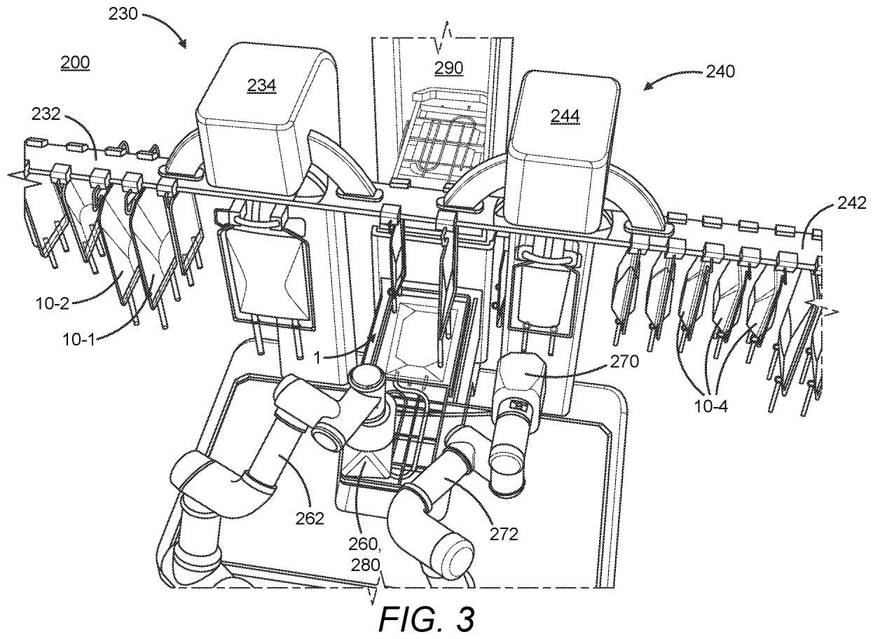

The processing station 110 may further comprise a storage section 190 that is configured to house a plurality of the mixing consumables 10-3. The storage section 190 may have a first portion 192 that is configured to store unused mixing consumables 10-3, and a second portion 194 that is configured to store used mixing consumables 10-3. An example of a storage section 290 will be described later in more detail in relation to FIGS. 2 to 4.

By providing an input conveying system 130 and an output conveying system 140, each of the consumables 10 may be positioned adjacent to the mixing section 120 where a fluid connection may be manipulated between the consumables 10, and reagent may be transferred. In other words, the conveying systems 130, 140 (which may alternatively be referred to as “carousels”) enable rapid management of inflow and outflow of the consumables 10. This rapid management allows a large number of sequential fluid connections to be made between the consumables 10 and the mixing system 120 via their corresponding tubes 11, without collisions or crowding in the system 100.

The system 100 comprises an automated means for manipulating 160 a closed fluid connection between two consumables 10 for the transfer of reagent therebetween. The automated means for manipulating 160 may form the closed fluid connection by creating a (sterile) tube weld between the respective flexible tubes 11 of the two consumables 10. In other words, the automated means for manipulating 160 may comprise an automated tube welding apparatus or automated “tube welder” 160.

As used herein, the term “tube welder” 160 refers to any device that is configured to join (i.e. weld) a first tube to a second such tube (preferably at their free ends), thereby providing an aseptic (and preferably closed) fluid connection between the tubes. The weld created between two tubes is preferably a sterile weld.

Briefly, an automated tube welder 160 may comprise a first clamping unit and a second clamping unit. Each clamping unit may comprise a pair of jaws movable between an open position for receiving a flexible tube therebetween, and a closed position for clamping a received tube. The clamping units may be located on a robotic arm. When a tube is clamped, the flexible tube is pinched shut, preferably inhibiting any flow of fluid therethrough. The clamping units may be operated to grip the tubes without clamping them shut; this may enable the tubes to be engaged and positioned without inhibiting flow of fluid. When a first tube is clamped by the first clamping unit and a second tube is clamped by the second clamping unit, a cutting blade may be heated and moved to intersect a clamped portion of both of the tubes. This cuts each tube into an upstream portion leading to a respective consumable, and a downstream portion that previously led to a closed end of the tube. Heat from the cutting blade is transferred to the tubes, thereby at least partially melting each flexible tube at the newly formed cut ends. Subsequently, the clamping units are moved so as to locate the upstream portions tubes adjacent to each other. The downstream portions may be discarded. Once the blade is removed, the upstream portions may be pressed into each other, thereby welding the tubes together to form a single tube. The joint may be referred to as a butt-weld. At this stage, the joint between the tubes may remain pinched shut; a pinch release mechanism may be operated to remove the pinched portion, thereby establishing a fluidic path through the joined tubes. Additionally, a quality control (QC) mechanism may be provided that verifies the integrity of each weld. The tube welder 160 allows for closed connections to be rapidly formed between tubes 11. The system 100 may comprise additional tube welders 160, which may be particularly advantageous if tube welding is the rate limiting step.

The automated means for manipulating 160 may further comprise a means for engaging and/or positioning a flexible tube 11. For example, the system 100 may comprise at least one robotic arm 162 with an end effector for gripping the tubes 11. For example, the means for manipulating 160 may comprise an end effector on a robotic arm 162 configured as a tube welder, where the clamping units of the tube welder 160 are configured to grip the tubes 11 without clamping them shut, thereby allowing the tubes 11 to be positioned. In this way, the robotic arm 162 may move to engage a first tube 11 connecting to a first consumable 10 and a second tube 11 connecting to a second consumable 10, and subsequently create a tube weld therebetween. Alternatively, the means for manipulating 160 may comprise a static tube welder located on the processing station 110, whereby a robotic arm with a gripping unit may engage and position the tubes 11 into the static tube welder 160.

The system 100 comprises an automated means for transferring 170 reagent between two fluidly connected consumables 10. The automated means for transferring 170 may be arranged to transfer reagent between two fluidly connected consumables 10 via their respective flexible tubes 11 once welded together to form said fluid connection. The automated means for transferring 170 may comprise a pumping arrangement 170 configured to apply a pumping action to said flexible tubes, preferably a peristaltic pumping action via a peristaltic pumping mechanism. For example, the system 100 may comprise a peristaltic pump 170.

As used herein, the term “peristaltic pump” may refer to a rotary peristaltic pump or a linear peristaltic pump. A peristaltic pump may be configured to compress a portion of the flexible tube 11, and then translate the compressed portion along the length of the tube 11 in a pumping direction, thereby forcing fluid through the tube 11.

Advantageously, the peristaltic pump 170 may allow fluid to be rapidly pumped through the tubes 11, with minimal wear to the tubes 11 and minimal chance of contamination. Furthermore, the pumping action of a peristaltic pump 170 is gentle on the cells. The peristaltic pump 170 may be configured as an end effector of a robotic arm 172. The end effector and/or the robotic arm 172 may be the same as the end effector and robotic arm 162 that provide the means for manipulating 160 a closed fluid connection. Preferably, the system 100 comprises a first robotic arm 162 with an end effector that provides the tube welder 160, and a second robotic arm 172 with an end effector that provides the peristaltic pump 170. The system 100 may comprise additional peristaltic pumps 170, which may be particularly advantageous if fluid transfer is the rate limiting step.

The system 100 also comprises (not shown) an automated means for sealing 180 a portion of each flexible tube 11 such that the one or more reagents in a consumable 10 can be aseptically sealed from the surrounding environment prior to disconnecting a fluid connection manipulated between two consumables 10. The means for sealing 180 may be referred to as a “tube sealer”. The means for sealing 180 may be provided on the same end effector as either, or both of, the tube welder 160 and/or the peristaltic pump 170. The means for sealing 180 is preferably an RF sealer, though may be any type of heat sealer that melts the flexible tubes 11 in order to prevent flow of fluid therethrough. Advantageously, providing a means for sealing 180 may help to prevent leakage from the consumables 10. This is particularly important for the output consumables 10-4 which may be stored for a significant amount of time and transported elsewhere once cryopreserved.

The system 100 may also comprise an automated means for disconnecting a fluid connection between two consumables 10. The automated means for disconnecting may be provided by the automated means for sealing 180 and is preferably an RF sealer. Alternatively, the tube welder 160 may provide the means for disconnecting a fluid connection, such as by using the heated cutting blade. In this way, once fluid is transferred between two consumables 10, the means for disconnecting may disconnect the consumables 10 may be disconnected thereby allowing them to be transported to different locations for storage or disposal.

The system 100 comprises an (automated) means for determining a quantity of fluid transferred to or from the mixing consumable 10-3 such as from an input consumable 10-1, 10-2, or to the output consumable 10-4. For example, the means for determining may determine the weight of a volume of the resulting mixture of first and second reagents that is transferred to the fourth consumable 10-4. The means for determining said quantity of fluid may be a weight sensor and/or may include any combination of a gravimetric, ultrasonic, flow, and/or a liquid level sensor. For example, the weight sensor may include a gravimetric sensor configured to monitor the weight of the output consumable 10-4 thereby determining the weight of the mixture that is transferred from the mixing consumable 10-3 into the output consumable 10-4.

Alternatively, or additionally, the weight sensor may include a gravimetric sensor configured to monitor the weight of the mixing consumable 10-3; the weight sensor may calculate the weight of fluid transferred into the output consumable 10-4 based on a change in weight of the mixing consumable 10-3 during the transfer.

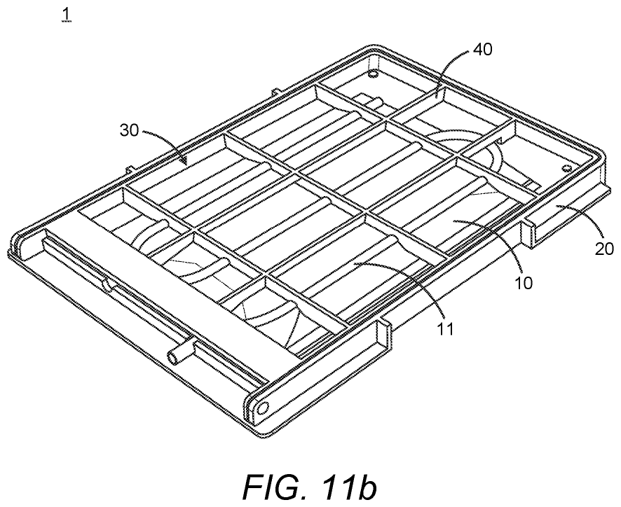

Alternatively, or additionally, the weight of the mixture in the output consumable 10-4 may be calculated based on a volume of fluid pumped by the automated means for transferring reagent 170; the volume of fluid pumped may be determined by a flow sensor, such as the flow sensor 175 described in relation to FIG. 10. The flow sensor may determine flow velocity by monitoring speed of bubbles moving through the tube 11. The gravimetric sensor may be located on a platform of the system 100, where the weight sensor determines the weight of a consumable 10 that is placed upon the platform; in particular, the gravimetric sensor may be located on the mixing zone 122 of the mixing system 120 thereby measuring the weight of the mixing consumable 10-3 when placed thereon.

Alternatively, or additionally, the gravimetric sensor may be located on the rail 142 of the output conveying system 140 and may measure the weight of the consumables 10 held on the rail 142. Optionally, the rail 132 of the input conveying system 130 may also have a gravimetric sensor.

Each consumable 10 may comprise an identification mark, such as a QR code or a bar code. Alternatively, or additionally, an RF tag or an NFC tag may be used. The identification mark may allow each consumable 10 be uniquely identified and tracked during a fill/finish operation and also during later stages such storage and distribution. The system 100 may have a means for identifying the identification mark on each of the consumables 10. The means for identifying may include at least one image capture device, which may be located on one or more of the robotic arms 162, 172. The means for identifying may be a machine vision system.

The system 100 may comprise one or more sensors configured to measure one or more parameters of the consumables 10. For example, the one or more sensors may include the gravimetric, ultrasonic, flow, and/or liquid level sensors discussed previously, and may include sensors for measuring the temperature of the mixing consumable 10-3. The one or more sensors may include a camera (not shown) for measuring progress of mixing in the mixing consumable 10-3. This camera may be the same camera that provides the means for identifying the identification marks on each consumable 10 or may be different camera.

An exemplary fill/finish operation performed at the system 100 will now be described. Firstly, a plurality of consumables 10 are loaded into the system 100. For example, at least one first consumable 10-1 and at least one second consumable 10-2 may be loaded onto the input conveying system 130, each containing a respective first reagent and second reagent. A plurality of empty fourth consumables 10-4 may also be loaded onto the input conveying system 130. At least one third consumable 10-3 may be loaded into the storage section 190, such as into the first portion 192. The loading of the consumables 10 may be performed by a human operator or may be performed by a separate robotic device in the bioprocessing system. When the consumables 10 are loaded into the system 100, the means for identifying may scan each of their corresponding identification marks so that each of the consumables 10 may be identified and tracked throughout the fill/finish operation.

The third consumable 10-3 may be moved from the storage section 190 to the mixing zone 122 of the mixing section 120, such as by an end effector of one of the robotic arms 162, 172. The tube welder 160 automatically welds the tube 11 connected to the first consumable 10-1 to the tube 11 connected to the third consumable 10-3. The peristaltic pump 170 automatically pumps fluid (e.g. cell material) from the first consumable 10-1 to the third consumable 10-3. The fluid connection between the first consumable 10-1 and the third consumable 10-3 is disconnected, and the corresponding tubes 11 are sealed thereby maintaining a closed system. In a similar manner, the tube welder 160 welds the tube 11 connected to the second consumable 10-2 to the tube 11 connected to the third consumable 10-3. The peristaltic pump 170 pumps fluid (e.g. cryoprotectant) from the second consumable 10-2 to the third consumable 10-3. The fluid connection between the second consumable 10-2 and the third consumable 10-3 is disconnected, and the corresponding tubes 11 are sealed thereby maintaining a closed system.

It will be appreciated that the steps described above may occur in a different order and some steps may occur concurrently. For example, the first consumable 10-1 does not need to be disconnected from the third consumable 10-3 before the tube welder 160 connects the second consumable 10-2 to the third consumable 10-3. Where both input consumables 10-1, 10-2 remain connected to the mixing consumable 10-3 during pumping, valves may be present on the tubes 11 to inhibit backflow of fluid. Furthermore, the transfer of fluid from the second consumable 10-2 may be used to flush any residual fluid left in the first consumable 10-1 (or vice versa). The pumping of reagent by the peristaltic pump 170 may occur at any time when the corresponding consumables 10 are connected. Additionally, the disconnection of the input consumables 10-1, 10-2 to the mixing consumable 10-3 may occur at a much later stage in the fill/finish operation or may not occur at all; for example, the input consumables 10-1, 10-2 and the mixing consumable 10-3 may be removed from the system 100 for disposal while still connected.

The third consumable 10-3 may be agitated to mix the reagents together. This may occur during pumping of one, or both, of the reagents into the third consumable 10-3, and/or may occur after both of the reagents have been pumped into the third consumable 10-3. The agitation may be achieved using any of the means for agitating described previously, such as the rocker plate and/or the roller. Similarly, the third consumable 10-3 may be cooled using the Peltier device or cold plate in the mixing zone 122. Once the first reagent and second reagent have been sufficiently mixed (which may be determined by the one or more sensors in the system 100), the tube welder 160 and the peristaltic pump 170 makes multiple sequential connections and transfers to a plurality of fourth consumables 10-4.

More specifically, the tube welder 160 welds the tube 11 connected to the third consumable 10-3 to the tube 11 connected to a fourth consumable 10-4. Then the peristaltic pump 170 pumps a predetermined weight of the mixture from the third consumable 10-3 into the fourth consumable 10-4, based on measurements by the weight sensor and/or flow sensor. Then the fluid connection between the fourth consumable 10-4 and the third consumable 10-3 is disconnected, and the corresponding tubes 11 are sealed thereby maintaining a closed system.

The above steps are repeated with a plurality of further fourth consumables 10-4 until the mixture in the third consumable 10-3 has been dispensed. The third consumable 10-3 may be moved into the second portion 194 of the storage section 192, such as by an end effector of one of the robotic arms 162, 172. Once each fourth consumable 10-4 is filled with the mixture, the fourth consumable 10-4 is moved away from the mixing section 120 using the output conveying system 140. Similarly, the empty first consumable 10-1 and second consumable 10-2 may be moved away from the mixing section 120 using the output conveying system 140. In this way, it may be possible to fill between 4 and 100 fourth consumables 10-4 with the mixture contained in the third consumable 10-3 without crowding of consumables 10 near the mixing section 120 or entanglement of the tubes 11.

Then, the consumables 10 may be unloaded from the system 100. The consumables 10 may be unloaded by a human operator or may be unloaded using a robotic device in the bioprocessing system. The empty first consumable 10-1 and second consumable 10-2 may be removed from the output conveying system 140 for disposal. The empty third consumable 10-3 may be removed from the second portion 194 of the storage section 190 for disposal. The plurality of filled fourth consumables 10-4 may be transported from the output conveying system 140 to a cryopreservation unit. Where the consumables 10 are unloaded by a robotic device, the identification marks on each of the consumables 10 may allow them to be differentiated by a machine vision system.

It will be appreciated that the loading and unloading steps may occur during other steps of the fill/finish operation. For example, empty fourth consumables 10-4 may be added to the input conveying system 130 and removed from the output conveying system 140 during dispensing of the mixture from the third consumable 10-3 into the plurality of fourth consumables 10-4. Advantageously, this means that the conveying systems 130, 140 do not need to have capacity to hold all the consumables 10 at the same time.

At least one of the automated means for manipulating a fluid connection 160, the automated means for transferring reagent 170, and the automated means for sealing 180 may be provided on the processing station 110. In the embodiment shown in FIG. 1, all the means for manipulating 160, the means for transferring 170, and the means for sealing 180 are provided on the processing station 110. In particular, the processing station has a base unit 111 divided into a first portion 111a and a second portion 111b. On an upper surface of the first portion 111a, the robotic arms 162, 172 may be mounted. An upper surface of the second portion 111b may support the mixing system 120 and/or the storage system 190. A housing 115 may be mounted to and extend vertically from the second portion 111b of the base unit 111. The housing 115 may have a portion that is configured to provide the mixing zone 122 for supporting the mixing consumable 10-3. The conveying systems 130, 140 may be mounted laterally to the housing 115. Specifically, the input conveying system 130 may comprise an input conveyor housing 134 with the rail 132 extending from a side portion of the input conveyor housing 134. The input conveyor housing 134 may have a front portion configured to hold the first and second input consumables 10-1, 10-2 when they are fluidly connected to the mixing consumable 10-3 supported in the mixing zone 122. In other words, the input conveying system 130 is arranged to position the consumables 10 for engagement by the means for manipulating a fluid connection 160 between each consumable 10 and the mixing system 120.

Likewise, the output conveying system 140 may comprise an output conveyor housing 144 with the rail 142 extending from a side portion of the output conveyor housing 144. The output conveyor housing 144 may have a front portion configured to hold at least one of the output consumables 10-4 when they are fluidly connected to the mixing consumable 10-3. In other words, the output conveying system 140 is arranged to position the consumables 10 for engagement by the means for manipulating a fluid connection 160 between each consumable 10 and the mixing system 120. As shown in FIG. 1, three output consumables 10-4 (two full and one empty) are held at the front portion of the output conveyor housing 144. In this way, the robotic arms 162, 172 are located adjacent to both the mixing consumable 10-3 and the conveying system 130, 140, thereby allowing closed fluid connections and fluid transfers to be manipulated between the consumables 10 without large lengths of tube 11 being required.

Alternatively, in a second embodiment of a closed system 200 shown in FIGS. 2 to 4, at least one of the automated means for manipulating a fluid connection 260, the automated means for transferring reagent 270, and the automated means for sealing 280 may be provided on a separate mobile unit 250 configured for automated cooperation with the processing station 210. The system 200 shares several features with the closed system 100 described in relation to FIG. 1, which for brevity will not be described again in detail. However, in this system 200, an autonomous mobile unit 250 provides all of the means for manipulating 260, the means for transferring 270, and the means for sealing 280. In this way, the mobile unit 250 may also perform other operations within the bioprocessing system as a whole and may facilitate loading and/or unloading of consumables 10 to/from the system 200 such as to/from external storage areas, other processing stations, and/or cryopreservation units.

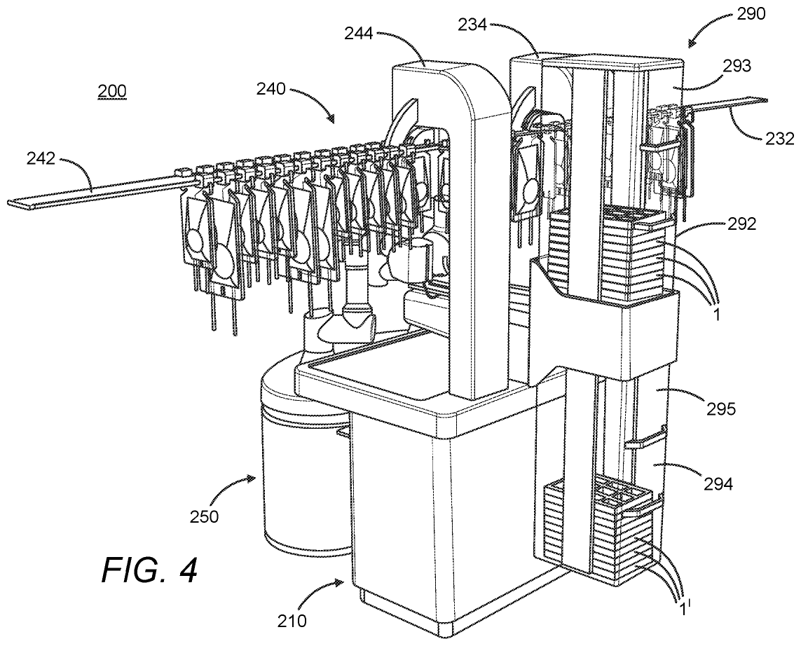

The system 200 also comprises a storage section 290. While not described in detail in relation to FIG. 1, it will be appreciated that the system 100 of the first embodiment may also comprise a storage section 190 similar to the storage section 290 of this second embodiment. The storage section 290 is configured to store a plurality of the third “mixing” consumables 10-3. The mixing consumables 10-3 may be held within a device 1 such as the device 1 described in relation to FIGS. 11a and 11b. As particularly shown in FIG. 4, the storage section 290 may have a first portion 292 that is configured to store a plurality of devices 1 holding unused mixing consumables 10-3, and a second portion 294 that is configured to store a plurality of devices 1′ holding used mixing consumables 10-3. It will be appreciated that these portions 292, 294 may be exchanged without affecting the present invention.

The first portion 292 may have a first hatch 293 to allow the mixing consumables 10-3 to be inserted and/or removed from the first portion 292. For example, a user may load one or more unused mixing consumables 10-3 into the first hatch 293 before one or more fill/finish operations occur. The second portion 294 may have a second hatch 295 to allow the mixing consumables 10-3 to be inserted and/or removed from the second portion 294. For example, a user may unload one or more used mixing consumables 10-3 from the second hatch 295 following completion of one or more fill/finish operations. Alternatively, or additionally, mixing consumables 10-3 may be inserted or removed from the storage section 290 during a fill/finish operation. As will be described later in relation to FIG. 11, the devices 1 may allow the consumables to be stacked for compact storage within the storage section 290, and the devices 1 may be moved from a closed configuration to an open configuration during a fill/finish operation.

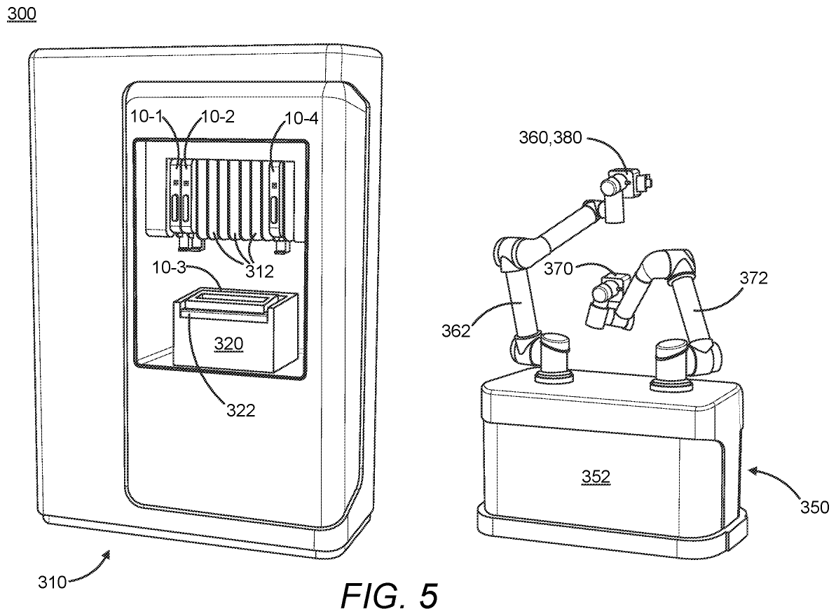

FIG. 5 shows a third embodiment of a closed system 300, which comprises a processing station 310 and a mobile unit 350. The mobile unit 350 provides the means for manipulating 360, the means for transferring 370 and the means for sealing 380 via a first robotic arm 362 and a second robotic arm 372. The robotic arms 362, 372 are mounted to a base unit 352 that may move autonomously relative to the processing station 310. Alternatively, the robotic arms 362, 372 may be mounted to the processing station 310 in a similar manner to the first embodiment, shown in FIG. 1.

In this third embodiment, a plurality of slots 312 are arranged in the processing station 310, each slot configured to receive and store a consumable 10. As depicted, the processing station 310 comprises ten slots 312, though it will be appreciated that any (reasonable) number of slots 312 may be present to hold any number of consumables 10. Here, a first consumable 10-1 for holding the first reagent can be seen held in the first slot 312 is, with a second consumable 10-2 for holding the second reagent shown held in the second slot 312. The processing station 310 also comprises a mixing system 320 with a mixing zone 322 for supporting a third “mixing” consumable 10-3. As discussed previously, the mixing system 320 may comprise a means for agitating and a means for cooling. A fourth “output” consumable 10-4, for receiving the mixture of the first reagent and the second reagent from the mixing system 320, can be seen held in the tenth slot 312, though it will be appreciated that additional output consumables 10-4 may be present in other slots 312. Each of the slots 312 may have a weight sensor, thereby allowing the amount of fluid in each of the output consumables 10-4 to be determined. The consumables 10 such as the input and output consumables 10-1, 10-2, 10-4 may be held within a device such as the device 50 described in relation to FIG. 12.

In this way, when following the method discussed previously, consumables 10 may be added and/or removed from the slots 312 when required. For example, the input consumables 10-1, 10-2, and a plurality of empty output consumables 10-4 may be installed into the slots 312 such as by a human operator or a robotic device (e.g. the mobile unit 350). Conceptually, the mobile unit 350 can be considered as providing an alternative form of automated conveying system, since it delivers the consumables 10 to the slots 312 of the processing station 310. A mixing consumable 10-3 may be installed into the mixing zone 322 of the mixing system 320 either from a storage section 390 (not shown) on the processing station 310 or from an external storage area. The mobile unit 350 may then manipulate the fluid connections and fluid transfers in the manner previously described, with consumables 10 being added and removed to/from the slots 312 whenever required. For example, once the reagents are transferred from the input consumables 10-1, 10-2 to the mixing consumable 10-3, the input consumables 10-1, 10-2 may be removed from the slots 312. Filled output consumables 10-4 may be removed from the slots 312 and moved to an external cryopreservation unit. Empty output consumables 10-4 may be added to available slots 312, such as to replace the removed input consumables 10-1, 10-2, and/or filled output consumables 10-4.

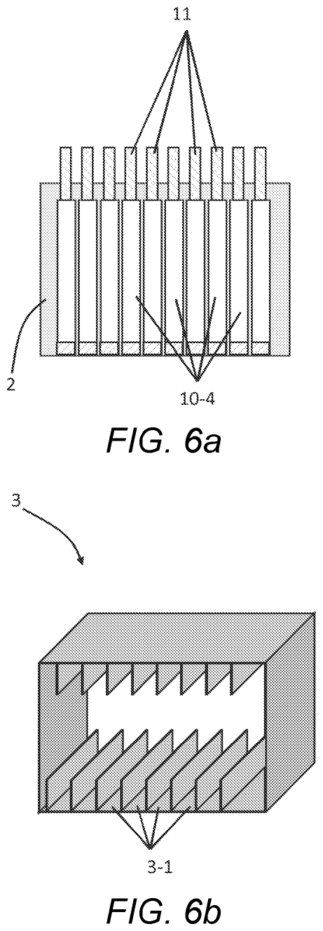

FIG. 6a shows an example of a plurality of (e.g. 10) output consumables 10-4 (only some labelled), where the plurality of output consumables 10-4 are held within a housing 2. These output consumables 10-4 may be referred to as vials 10-4. Each of the vials 10-4 has a tube 11 (only some labelled) to facilitate welding to other tubes in the closed system 100, 200, 300, such as the tube 11 connected to the mixing consumable 10-3.

FIG. 6b shows an example of a “cassette” (or “cartridge”) frame 3 that may be used to hold a plurality of output consumables 10-4 within a corresponding opening 3-1 (only some labelled). In this way, when all the output consumables 10-4 have been filled with the mixture from the mixing consumable 10-3, the frame 3 can be moved to the cryopreservation unit, rather than individually transporting all the output consumables 10-4. Furthermore, by storing the output consumables 10-4 in a single frame 3, only one identification mark may be required to identify all of the stored output consumables 10-4.

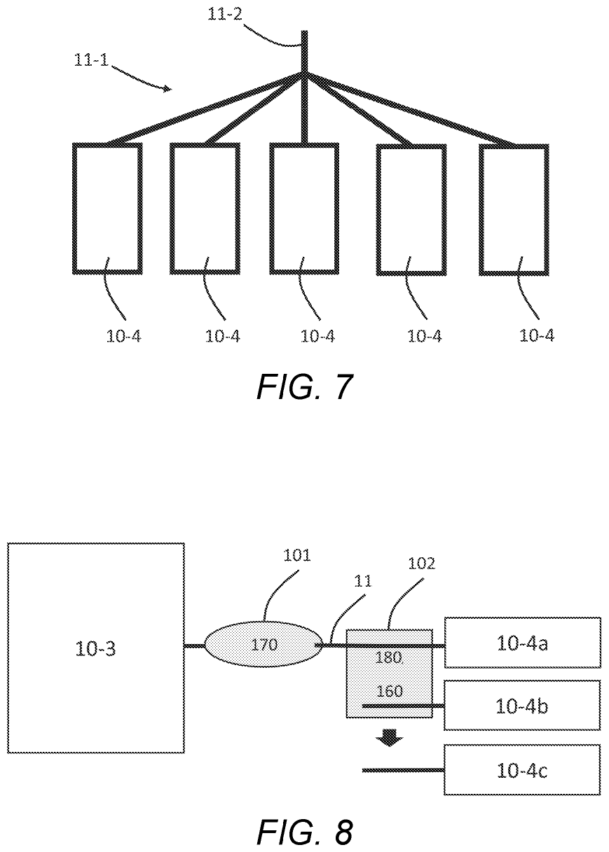

FIG. 7 shows a tube network 11-1 that connects a plurality of (e.g. five) output consumables 10-4 to a single fill portion 11-2. In this way, the tube welder 160 only needs to form a single connection between the tube 11 connected to the mixing consumable 10-3 and the fill portion 11-2, which may speed up the fill/finish process. Then the peristaltic pump 170 may transfer the mixture to all of the preconnected output consumables 10-4. The tube network 11-1 may be sealed when each of the output consumables 10-4 receives the required weight of the mixture. Then the output consumables 10-4 may be disconnected, so that each output consumable 10-4 connects to only a single tube 11.

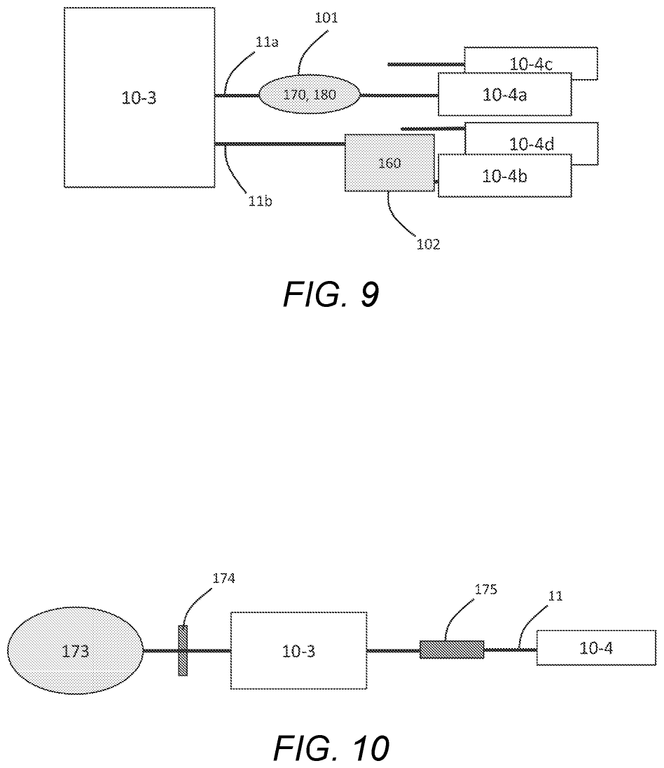

A first workflow for transferring the mixture from the mixing consumable 10-3 to a plurality of output consumables 10-4 will now be described with reference to FIG. 8. In this example, the closed system 100, 200, 300, has a first tool 101 that provides the peristaltic pump 170 and a second tool 102 that provides the tube welder 160 and the tube sealer 180, though it will be appreciated that these may be provided as separate tools. In this example, the first tool 101 may be a static tool, and the second tool 102 may move, such as on a robotic arm. The mixing consumable 10-3 has a single tube 11 connected thereto.

As depicted, the tube welder 160 has connected the mixing consumable 10-3 to a first output consumable 10-4a via their respective tubes 11. Then the peristaltic pump 170 performs a controlled transfer of fluid from the mixing consumable 10-3 into the first output consumable 10-4a. Then the second tool 102 seals the first output consumable 10-4a with the tube sealer 180 and welds the second output consumable 10-4b to the mixing consumable 10-3 via their respective tubes 11. Then this process may repeat in order to transfer fluid to a plurality of further output consumables 10-4. More specifically, the peristaltic pump 170 then transfers the mixture into the second output consumable 10-4b. While this occurs, the second tool 102 may move into position ready to seal the second output consumable 10-4b and weld a third output consumable 10-4c to the mixing consumable 10-3. The time taken to perform one cycle of this process may be about 30 seconds for pumping, 30 seconds for sealing, and one minute for welding. This may therefore allow 30 output consumables 10-4 to be filled within one hour.

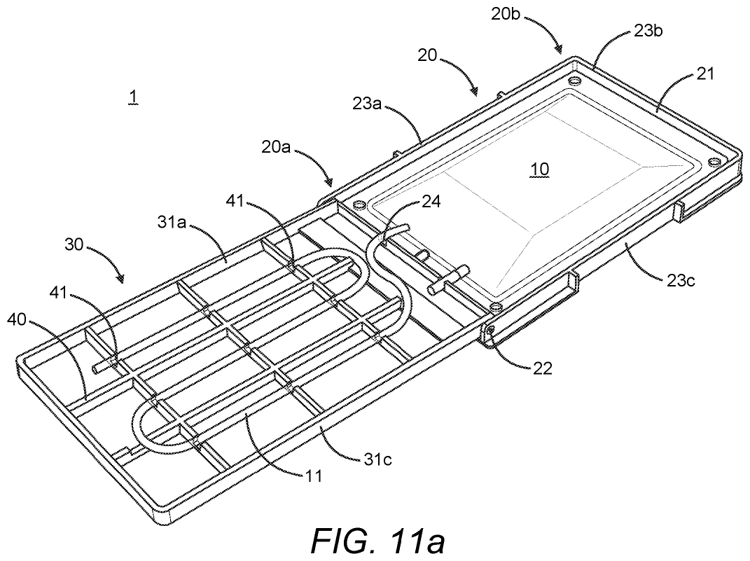

A second workflow for transferring the mixture from the mixing consumable 10-3 to a plurality of output consumables 10-4 will now be described with reference to FIG. 9. In this workflow, the tube welder 160 and the pump 170 operate in parallel, allowing more output consumables 10-4 to be filled within one hour. However, this workflow is more complicated since output consumables 10-4 are operated in two different lines (or similar) to avoid tying the tubes 11 in knots. In this example, each system 100, 200, 300 has a first tool 101 that provides the peristaltic pump 170 and the tube sealer 180, and a second tool 102 that provides the tube welder 160, though it will be appreciated that the peristaltic pump 170 and tube sealer 180 may be provided on separate tools. The mixing consumable 10-3 has a first flexible tube 11a and a second flexible tube 11b connected thereto. The first tube 11a and the second tube 11b may have pinch valves to prevent flow of fluid therethrough.

At a first step, the first tool 101 pumps fluid through the first tube 11a into a first output consumable 10-4a and seals the first output consumable 10-4a. Simultaneously, the tube welder 160 welds the second tube 11b to a second output consumable 10-4b. A third output consumable 10-4c and a fourth output consumable 10-4d may be brought into position for subsequent steps.

At a second step, the second tool 102 with the tube welder 160 moves to the third output consumable 10-4c and welds the first tube 11a to the third output consumable 10-4c. The first tool 101 moves to pump fluid through the second tube 11b into the second output consumable 10-4b and subsequently seals the second output consumable 10-4b.

At a third step, the second tool 102 with the tube welder 160 moves to the fourth output consumable 10-4d and welds the second tube 11b to the fourth output consumable 10-4d. The first tool 101 moves to pump fluid through the first tube 11a into the third output consumable 10-4c and subsequently seals the third output consumable 10-4c. A fifth and sixth output consumable (not shown) may be brought into position for subsequent steps.

At a fourth step, the second tool 102 with the tube welder 160 moves to the fifth output consumable and welds the first tube 11a to the fifth output consumable. The first tool 101 moves to pump fluid through the second tube 11b into the fourth output consumable 10-4d and subsequently seals the fourth output consumable 10-4d.

The above-described steps may be repeated in order to transfer fluid to a plurality of further output consumables 10-4. The time taken to fill one output consumable 10-4 may be about 30 seconds for movement and the longer of: the pump and seal time, and the weld time, which may be about a minute. This means that about 40 output consumables 10-4 may be filled in one hour.

FIG. 10 shows an alternative means for transferring 170 reagent between two fluidly connected consumables 10. This means for transferring 170 may be implemented into any of the systems 100, 200, 300 described herein. The means for transferring 170 may comprise a valved air source 173 connected to the mixing consumable 10-3 via a sterile air filter 174. The flexible tube 11 that connects between the mixing consumable 10-3 and each of the plurality of output consumables 10-4 comprises a flow sensor 175. The flow sensor 175 is preferably a disposable medical grade flow sensor 175. Preferably, the welding, sealing and/or disconnecting occurs on the flexible tube 11 between the flow sensor 175 and the output consumables 10-4 (rather than between the mixing consumable 10-3 and the flow sensor 175).

Advantageously, the flow sensor 175 allows a precise volume of fluid to be transferred into each of the output consumables 10-4. In this way, air may be pumped into the mixing consumable 10-3 by the valved air source 173 such that the mixture in the mixing consumable 10-3 is forced out through the flexible tube 11 into the output consumable 10-4 due to the increase in pressure. It will be understood that pumping air through the sterile air filter 174 satisfies the requirements of a functionally closed system, which is considered sufficient to prevent contamination between the contents of the consumables 10 and the surroundings.

A device 1 for holding a consumable 10 will now be described with reference to FIGS. 11a and 11b. The device 50 is configured to hold a consumable 10 having at least one flexible tube 11 fluidly connected thereto. The device 1 comprises a structure 20 (“first portion”) for holding the consumable 10. The structure 20 may have a longitudinal axis with a first end 20a and a second end 20b.

The structure 20 may be configured as a tray 20. As such, the tray 20 may define a recess 21 shaped to receive the consumable 10 therein. The tray comprises a pair of opposing side walls 23a, 23c and at least one end wall 23b, which together generally define the recess 21, which here is generally rectangular.

The recess 21 ideally has dimensions comparable to those of the consumable 10 such that the consumable 10 fits tightly into the recess 21, thereby holding the consumable 10 in position. This reduces the flexibility of the consumable 10 by retaining the consumable 10 in a given shape.

The tray 20 may be rigid and may be made of any suitable material, such as plastic or metal. In other examples, the tray 20 may comprise a material that has a degree of natural flex, such as a material with elastic properties. In this way, the consumable 10 may be forced into the recess 21 by stretching one or more sides of the tray 20 slightly upon insertion. Once released, the sides of the tray 20 flex back into their original shape with the consumable 10 is inserted, thereby securing the consumable 10.

In alternative embodiments, the tray 20 may comprise a rectangular plate with an aperture through its centre thereby forming an “open” structure. The structure 20 may further comprise at least one clamp configured to secure the consumable 10 to the plate. The at least one clamp may be located on structure as to hold the consumable 10 against gravity. When more than one clamp is present, the clamps may be located on more than one side of the structure 20. This may allow the device 1 to be positioned in different orientations while still holding the consumable 10 in place and minimising the changes in its shape.

The device 1 comprises a lid 30 (“second portion”) configured to cover the consumable to secure it within the recess 21 of the tray, and further to retain the flexible tube 11 connected to the consumable 10. The lid 30 may comprise a frame 40 having a plurality of tube retaining elements 41 arranged to retain the flexible tube 11 at a plurality of positions along the predetermined path. The frame 40 may be configured as grid comprising a first set of parallel bars crossing (or intersecting) at reoccurring intervals with a second set of parallel bars.

Due to each tube retaining element 41 being located at an intermediate position on the grid 40, for example at the midpoint of two intersections, the predetermined path followed by the tube 11 may be a winding (e.g. serpentine) path as shown. This is advantageous as it allows a long tube to be held in a compact arrangement by the device 1, avoiding the tangling of tubes 11 with one another and other components in the bioprocessing system or the processing station 110 or other tubes 11. This further allows the tubes 11 to be long, which is desirable for tube welding since it allows many connections and disconnections to be made to the different locations along the length of the tube 11.

The tube 11 may be secured to each of the plurality of tube retaining elements 41 by exerting a force on the tube 11 so as to push the tube 11 into the tube retaining element 41, resulting in the tube retaining elements 41 securing the tube 11 at a given position. The tube retaining element 41 may alternatively comprise any suitable means for coupling the portion of tube 11 to the frame 40 such as a hook or a clasp. The portion of tube 11 retained by the tube retaining element 41 may be permanently retained or may be removably secured.

The lid 30 may be secured at the first end 20a of the tray 20. The lid 30 may have a width dimension less than that of the tray 20, such that the tray 20 may receive a portion of the lid 30 by a third recess on its upper surface. This provides an overlap of opposing side walls 23a, 23c of the tray with opposing side walls 31a, 31c of the frame 40. In this way, each side wall 23a, 23c of the tray 20 may be attached to the respective side wall 31a, 31c of the frame 40.

A second recess 24 (e.g. gap or slot), through which the tube 11 may pass, is provided in a side of the lid 30 that attaches to the first end 20a of the tray 20. The second recess 24 is preferably aligned with the portion of the consumable 10 that connects to the flexible tube 11. There may be more than one such second recess 24 present in the side of the lid 30 for when the consumable 10 comprises more than one tube 11.

Preferably, the lid 30 is hingedly attached to the tray 20 for hinged movement between an open configuration and a closed configuration. FIG. 11a shows an open configuration in which a longitudinal axis of the tray 20 is aligned with a longitudinal axis of the lid 30, such that the lid 30 is in a parallel plane to the tray 20. In other words, in an open configuration the device 1 may provide a generally flat plate. In FIG. 11b, the device 1 is shown after the lid 30 has hingedly moved to a closed configuration in which the lid 30 has rotated about the first end 20a of the tray 20 to fold inward across the upper surface of the tray 20.

The lid 30 may be attached using a pair of screws 22 at opposed sides at the first end 20a of the tray 20. Each of the screws 22 may be inserted perpendicular to the longitudinal axis of the tray 20 through one of the side walls 23a, 23c of the tray 20, and through one of the corresponding side walls 31a, 31c of the frame 40, so as to hingedly attach the tray 20 and lid 30 to one another. The tray 20 and lid 30 can pivot about the screws 22 whereby to move hingedly between the open configuration and closed configuration. The lid 30 may be securable to the tray 20 to retain the device 1 in the closed configuration.

In other examples, the lid 30 may be hingedly attached to the tray 20 by another means. This may include at least one of: a butt hinge, a ball bearing hinge, a piano hinge, and a strap hinge. In these examples, the attachment means may be positioned substantially central to a first end 20a of the tray 20 or alternatively may be positioned at opposed sides of the first end 20a of the tray 20. Alternatively, the lid 30 may slide relative to the tray 20, such as parallel to the longitudinal axis of the tray 20.

An alternative device 50 for holding a consumable 10 will now be described with reference to FIGS. 12a and 12b. The device 50 is configured to hold a consumable 10 having at least one flexible tube 11 fluidly connected thereto. In the example shown in FIG. 12a, the consumable 10 is connected to two flexible tubes 11. The device 50 comprises a housing 70 configured to hold the consumable 10; in other words, the housing 70 provides a first portion of the device 50 for holding the consumable 10. The device 50 may also provide insulation and/or heat conduction with the consumable 10, such that temperature of each consumable 10 can be individually adjusted.

An upper surface and lower surface may be provided on the housing 70 separated by a pair of opposing side walls 73a, 73c (i.e. a first and second side wall 73a, 73c), and at least one end wall 73b, thereby forming a cuboidal shape. The housing 70 may have a longitudinal axis with a first end 70a and a second end 70b.

The housing 70 may comprise a tray 70 with a cavity 71 shaped to receive the consumable 10 therein. The upper surface of the housing 70 may be a removable cover 72 that substantially encloses the consumable 10 within the cavity 71; in this way, the consumable 10 may be conveniently added and/or removed from the device 50. Furthermore, this means that the device 50 has a rigid outer surface that may protect the consumable 10 and may enable the device 50 to be reliably inserted to slots 312 in a processing station 310 of a closed system 300.

Preferably, the cavity 71 has dimensions comparable to those of the consumable 10 such that the consumable 10 fits tightly into the cavity 71, thereby holding the consumable 10 in position. This reduces the flexibility of the consumable 10 by retaining the consumable 10 in a given shape. The housing 70 may be rigid and may be made of any suitable material, such as plastic or metal. In other examples, the housing 70 may comprise a material that has some flex, such as any material with elastic properties. In this way, the consumable 10 may be forced into the cavity 71 by stretching the cavity 71 slightly upon insertion. The housing 70 will then flex back into its original shape once the consumable 10 is inserted, thereby securing the consumable 10. Advantageously, use of the device 50 to house a consumable 10 comprising a bag prevents the bag from bulging outwards when full. The housing 70 may also contain external insulation, and routing for internal cold airflow, such that a consumable 10 contained within the housing 70 can be kept at a specified temperature. A thermistor (not shown) may also be inbuilt to the housing 70 to monitor temperature.

The housing 70 may comprise at least one clamp 75 to hold the consumable 10 inside the cavity 71. In this example, the housing 70 has a clamp 75 in the cavity 71 towards the first end 70a of the housing 70. The clamp 75 may be a tab or a hook. The consumable 10 may be mounted via a hanging aperture provided in the bag of the consumable 10.

The housing 70 may comprise a means for engagement 76 provided on an external surface of the housing 70. In this example, the means for engagement 76 is a handle 76 attached to the first side wall 73a. The handle 76 may allow the device 50 to be manipulated and moved by a human operator and/or a robotic device such as a robotic arm 162, 172. For example, the handle 76 may allow the device 50 to be carried, installed and/or removed from the slots 312 in the processing station 310 of the closed system 300 described herein.

One or more ribs 78 may be provided around the perimeter of the housing 70, extending between the upper and lower surfaces of the housing 70. An identification mark, such as a barcode, QR code or NFC code may be provided on the device 50 to allow the device 50 to be identified by a machine vision system. For example, the devices 50 may be automatically identified when inserted into a slot 312 of the processing station 300.

The housing 70 may comprise at least one recess 74 and an end portion of the housing (e.g. the second end 70b), through which the tube 11 may pass. The recess 74 is preferably aligned with the portion of the consumable 10 that connects to the flexible tube 11. There may be a plurality of recesses 74 present on the housing 70 for when the consumable 10 is fluidly connected to more than one tube 11.

The device 50 comprises a second portion 80 configured to retain the flexible tube 11 connected to the consumable 10. The second portion 80 may extend from the second end 70b of the housing 70 and is preferably located adjacent to the recesses 74. The second portion 80 may comprise a plurality of tube retaining elements 81 (e.g. tube clips) to retain the flexible tube 11 at a plurality of positions along a predetermined path. In this example, the second portion 80 has a pair of tube retaining elements 81, the tube retaining elements 81 being spaced apart such that a portion of the tube 11 may be held between them in a substantially taut manner to facilitate engagement by a robotic device. In this way, a robotic device may engage the tube 11 at a position between the pair of tube retaining elements 81.

The tube 11 may be secured to each of the tube retaining elements 81 by exerting a force on the tube 11 so as to push the tube 11 into the tube retaining element 81, resulting in the tube retaining elements 81 securing the tube 11 at a given position. The tube retaining elements 81 may alternatively comprise any suitable means for coupling the portion of tube 11 to the second portion 80 such as a hook or a clasp. The portion of tube 11 retained by the tube retaining elements 81 may be permanently retained or may be removably secured.

The device 50 may comprise a means for cooling 77 the consumable 10 held within the housing 70. In this example, the means for cooling 77 is at least one air port 77 (or “air duct”) in the first portion 70 and/or the second portion 80 of the device 50; in this way, cool air may be supplied to the at least one air port 77 in order to cool the consumable 10. Specifically, the device 50 comprises a first external air port 77a in communication with an internal air port 77b to facilitate the introduction of air into/out of the cavity 71. A second external air port 77c is provided in the housing 70 to allow air to flow out of/into the housing 70.

While the foregoing is directed to exemplary embodiments of the present invention, it will be understood that the present invention is described herein purely by way of example, and modifications of detail can be made within the scope of the invention. Furthermore, one skilled in the art will understand that the present invention may not be limited by the embodiments disclosed herein, or to any details shown in the accompanying figures that are not described in detail herein or defined in the claims. Indeed, such superfluous features may be removed from the figures without prejudice to the present invention. Moreover, other and further embodiments of the invention will be apparent to those skilled in the art from consideration of the specification, and may be devised without departing from the basic scope thereof, which is determined by the claims that follow.

1. A closed system for mixing fluids for use in a bioprocessing system, comprising:
automated means for manipulating a tube weld between a first tube fluidly connected to a first consumable and another tube fluidly connected to a mixing consumable, said tube weld forming a closed fluid connection between the first consumable and mixing consumable;
automated means for transferring a first fluid contained by the first consumable to the mixing consumable via the fluid connection; and
automated means for determining a quantity of fluid transferred to or from the mixing consumable,
wherein the system is further configured to manipulate a tube weld between a second tube fluidly connected to a second consumable and said another tube fluidly connected to the mixing consumable, and transfer a second fluid therebetween to be mixed with the first fluid in the mixing consumable.

2. The system of claim 1, wherein the system is further configured to manipulate a tube weld between said another tube fluidly connected to the mixing consumable and a further tube fluidly connected to an output consumable, and transfer at least some of the mixture of first and second fluids contained in the mixing consumable to the output consumable.

3. The system of claim 1, further comprising automated means for sealing and/or disconnecting each tube once a transfer of fluids to or from the mixing consumable is complete.

4. The system of claim 1, wherein the system comprises an automated processing station.

5. The system of claim 4, wherein at least one of the automated means for manipulating a tube weld, the automated means for transferring fluid and the automated means for sealing is provided on the processing station.

6. The system of claim 4, wherein at least one of the automated means for manipulating a tube weld, the automated means for transferring fluid and the automated means for sealing is provided on a separate mobile unit configured for automated cooperation with the processing station.

7. The system of claim 1, wherein at least one of the automated means for manipulating a tube weld, the automated means for transferring fluid and the automated means for sealing comprises a robotic device, such as a robotic arm having an end effector configured to perform one or more of the operations.

8. The system of claim 1, wherein the automated means for transferring comprises a pumping arrangement configured to apply a pumping action to said flexible tubes.

9. The system of claim 1, further comprising automated means for mixing the first and second fluids within the mixing consumable.

10. The system of claim 9, wherein the means for mixing comprises an automated mixing system having a mixing zone in which the mixing consumable is positioned to receive the first and second fluids from the first and second consumables, respectively.

11. (canceled)

12. The system of claim 9, wherein the mixing system comprises means for controlling the temperature of the mixing consumable, such as a Peltier device or plate configured to cool the mixing consumable located in the mixing zone.

13. The system of claim 4, wherein the processing station comprises a plurality of slots configured to retain said first consumable, said second consumable, and said output consumable.

14. (canceled)

15. The system of claim 4, wherein the processing station comprises an automated conveying system configured to deliver at least one of said first consumable and said second consumable to the mixing system for supply of at least one of the first fluid or the second fluid to the mixing system.

16. The system of claim 15, wherein said automated conveying system is further configured to deliver both the first and second consumables to the mixing system for supply of both the first fluid and the second fluid to the mixing system, the system further comprising an automated conveying system configured to remove the output consumable from the mixing system once filled with the resulting mixture of first and second fluids.

17. The system of claim 15, wherein the, or each, automated conveying system is arranged to position the consumables for engagement by the means for manipulating a tube weld between each consumable and the mixing system.

18. The system of claim 15, wherein the conveying system comprises a motorised rail arrangement in which the consumables are suspended from a rail along which they can be moved via a motorised track.

19. The system of claim 1, further comprising means for identifying an identification mark on at least one of the consumables.

20. The system of claim 1, further comprising one or more sensors configured to measure one or more parameters of the consumables.

21. (canceled)

22. An automated method of mixing fluids within a closed system for use in a bioprocessing system, the method comprising:
mixing a first fluid, contained by a first consumable, with a second fluid, contained by a second consumable, within a mixing consumable prior to filling an output consumable with a resulting mixture of said first and second fluids, wherein each consumable comprises a flexible tube arranged to provide a fluid conduit to the one or more fluids contained by the consumable;
manipulating a tube weld between two of said consumables for the transfer of fluid therebetween;
determining the weight of a volume of the resulting mixture of first and second fluids that is transferred to the output consumable; and
sealing a portion of each flexible tube such that the one or more fluids in a consumable can be isolated from the surrounding environment prior to disconnecting a fluid connection manipulated between two consumables.

23. The method of claim 22, wherein at least one of the steps of mixing, manipulating, determining and sealing is automated.

24.-27. (canceled)
